(19) United States
(12) Patent Application Publication
(10) Pub. No.: US 2005/0191386 A1
(43) Pub. Date: Sep. 1, 2005

(54) Nutritional supplement compositions and methods

(76) Inventor: Jason P. Adams, New York, NY (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/787,334

(22) Filed: Feb. 26, 2004

(51) Int. Cl. A23L 1/30

(52) U.S. Cl. 426/72; 426/592

(57) ABSTRACT

Compositions and methods are provided for supplementing a nutrition-depleting beverage. A nutrient supplement typically includes an active ingredient effective to compensate for the nutrient depletion incurred by consuming the beverage, an excipient, and a delivery formulation. An active ingredient may include a vitamin, mineral, electrolyte, or other nutrient. An excipient may include anti-oxidants, pH buffers, flavor masking agents, odor masking agents, preservatives, timed-release mechanisms, and other excipients added to the beverage to support delivery of the active ingredient from the beverage to the bloodstream of a user. A method for increasing nutritional constituents otherwise subject to a deficiency in a user as a consequence of consumption of a beverage, may include a method for making and administering a supplemented beverage for increasing nutritional constituents.

### BACKGROUND

1. The Field of the Invention

This invention relates to nutrient supplementation by the co-administration of nutrients in beverages and auxiliary comestibles, targeting the nutrient deficits commonly encountered in persons consuming these beverages.

2. The Background Art

The practice of formulating and consuming beverages has been known to mankind for millennia. In fact, some of the earliest known beverages, aside from water, may include intoxicating beverages (e.g. wine, beer, ale, lager and other fermented spirits), fruit and vegetable juices, and milk. As mankind has become more sophisticated and technology has developed, so has the desire for more useful and pleasing beverages. Accordingly, beverages have developed in taste, odor, appearance, texture, content, utility, and the like.

Historical records, including biblical references and archaeological evidence indicate that mankind has produced and consumed alcoholic beverages for thousands of years B.C. From the earliest records of alcohol use, consumption may largely have been in the form of wines, which may be directly derived from fermentation of various fruits, especially from berries, grapes, dates and other fruits that may be native to the Mediterranean climate, or in the form of beers, which may be derived from the fermentation of various grains, especially from hops, barley, and oats.

Beginning around the 12^{th} Century, techniques for distilling alcohol became known. The ability to separate alcohol from fermented fruits and wines became possible and found some popularity. Distillation may be based upon the physical nature of alcohol having a different temperature for phase change. Alcohol has a lower freezing point and a lower boiling temperature than water. Therefore, by controlling the temperature or heat being applied to heat or cool a quantity of liquid containing alcohol, non-alcohol portions of the liquid may be separated. The result is a more highly concentrated alcohol liquid.

Around the 15^{th} Century, techniques for distilling alcohol from grains became known. Distillation from grains may have been less costly than production of wines, and subsequently the consumption of alcohol dramatically increased in society. As alcohol quality improved and quantity consumed increased, physicians of the time began to notice and record a multitude of adverse effects that were encountered in those who imbibed alcohol in significant amounts.

Beginning around the 19^{th} and early 20^{th} Centuries a temperance movement began in many areas of the world, especially in Europe and America. This movement called upon the public to abstain from alcohol use, or otherwise decrease intake. One result of the temperance movement was the prohibition of alcohol production and consumption in the United States from 1919 to 1933. Government leaders and policy makers later decided that absolute prohibition of alcohol did not result in the hoped for benefits to society.

Following the prohibition period, a significant effort was undertaken to find clinical and scientific explanations for alcohol dependence and the serious adverse effects that may occur with prolonged alcohol intake. These research efforts continue today. However, early research focus has resulted in two main conclusions. First, alcohol dependence may be classified as a disease. Second, alcohol dependence may have both physical and mental dependence processes.

With a greater acceptance by society that chronic, excessive alcohol use may be approached as a disease, valuable data has been accumulated over the past several decades indicating that chronic, excessive alcohol use may be a leading cause of liver cirrhosis, hepatitis, and liver cancer. In addition, chronic, excessive alcohol use may also be associated with pancreatitis, cardiomyopathy, gastrointestinal cancer, hemorrhagic stroke, and many other conditions.

Over about the past several centuries many observations and advances have occurred in understanding the importance and function of nutrition. In general, a balanced diet may consist of macronutrients, vitamins, minerals, and electrolytes. Macronutrients may include, for example and not by way of limitation, fats, proteins, carbohydrates and fiber. In order for the body to properly utilize these macromolecule components, micronutrients may be required in order to support the biochemical mechanisms and pathways within the body. Micronutrients may include vitamins, minerals, electrolytes, and other nutrients.

Much of the initial knowledge concerning vitamins may have been learned from observations of some notable diseases (e.g. ricketts, pellagra, night blindness, and beriberi). Many of these diseases were believed to be due to a deficiency of certain dietary factors. In fact, the term “vitamin” was defined in 1912 in a paper by a Polish-American scientist named Casimir Funk. He included a description of an anti-beriberi compound that he believed was within the amine chemical family. The compound was initially called “Vital Amine” which was later shortened to “vitamine” and subsequently to vitamin. This anti-beriberi compound was later defined as vitamin B1, and also known today as thiamine.

Today, the word vitamin may be used more generally to indicate many compounds important to physiology and homeostasis in humans and animals. Many important vitamins may be identified. The B-vitamins, often referred to as B-complex vitamins, may include vitamin B1 (thiamine), vitamin B2 (riboflavin), vitamin B3 (niacin), vitamin B5 (pantothenic acid), vitamin B6 (pyridoxine), vitamin B12 (cyanocobalamin), and folate (folic acid; sometimes referred to as vitamin B9). The B-complex vitamins may play important roles in assisting the body to breakdown large, macromolecules into smaller components that may be utilized for bio-energy needs.

Vitamin C (ascorbic acid) is an important anti-oxidant for the body. It may help prevent the formation of or minimize the effects of certain toxic metabolites that result from homeostasis. Vitamin C may also help in the production of collagen. Vitamin C and the B-complex vitamins are sometimes known or referred to as the water-soluble vitamins, in accordance with their chemical properties.

Fat-soluble vitamins may include vitamin A, vitamin D, vitamin E, and vitamin K. Vitamin A may be important to supporting the cells and materials needed in the visual system. Vitamin D may have many roles in the body, which may include promoting stronger and healthier bones, as well as regulating the balance of phosphorous and calcium in the body. Vitamin E also serves as an important anti-oxidant compound. Vitamin K helps maintain clotting factors to promote integrity of the circulatory system.

Often accompanying vitamins in their work in the body are any number of pro-vitamins, co-factors, and co-enzymes. These may include, for example and not by way of limitation, nicotinamide adenine dinucleotide (NAD), flavin adenine dinucleotide (FAD), biotin, and the like.

A number of minerals also have important roles in the body. These minerals may include, for example and not by way of limitation, magnesium, zinc, selenium and calcium, as well as many others. Electrolytes important to the body, may include potassium, sodium, chloride, and phosphate. In some instances there may be cross-over between the mineral and electrolyte classifications. For example, magnesium and calcium may be classified as either minerals or electrolytes.

Several additional nutritional deficiency conditions may be recognized. Improper intake of fats, proteins, carbohydrates, vitamins, minerals, electrolytes, and the like may lead to any number of nutritional deficiency conditions. For example, and not by way of limitation, a deficiency of vitamin C may result in a condition known as scurvy. This condition was especially prevalent in those who sailed at sea for many months without sufficient intake in their diet of fruits and vegetables, especially citrus fruits (e.g. oranges, lemons, limes).

In addition to scurvy (i.e., vitamin C deficiency) and beriberi (i.e., vitamin B1 deficiency), as described above, other specific nutritional deficiency disorders may be identified and characterized by their historical names, as follows: pellagra (i.e., vitamin B3 deficiency), megaloblastic anemia (i.e., vitamin B12 and folate deficiency), ricketts (i.e., vitamin D deficiency), marasmus (i.e., protein deficiency), kwashiorkor (i.e., protein deficiency and carbohydrate excess) and many others.

Nutritional deficiency disorders have prompted the development of numerous guidelines for defining the proper quantities of nutrients for intake. One important guideline is labeled the “Recommended Dietary Allowances” (RDA) and is published by the United States National Academy of Sciences—National Research Council. The RDA's for many vitamins and minerals are set forth in National Research Council guidelines.

Nutritional deficiency may result from numerous mechanisms and may include, (1) ingestion of foods and beverages that are themselves nutritionally deficient; (2) ingestion of foods and beverages that may deplete nutrient stores in the body; (3) ingestion of foods and beverages that may interfere with the absorption of nutrients in the gastrointestinal system; and (4) co-morbidity with diseases, disorders, or conditions that may deplete nutrient stores in the body.

Alcohol, especially chronic, excessive intake of alcoholic beverages, may cause nutritional deficiency through any or all of the above listed mechanisms. In general, alcoholic beverages may be considered to have calories (energy) but no significant nutritional value. Alcoholic beverages may promote diuresis and thereby prevent the resorption of water-soluble nutrients, including B-complex vitamins and vitamin C. Alcoholic beverages may interfere with the absorption of thiamine and other nutrients from the gastrointestinal system. Finally, co-morbid conditions that may develop from chronic, excessive intake of alcohol may prevent the liver, kidneys, muscles, lungs, brain, and gastrointestinal system from properly processing and storing nutrients.

Alcoholic beverages typically are high in calories, but have few or no other nutrients within them. Moreover, due to their high caloric content, they often account for 50% or greater of the daily intake of calories of an individual. As a result, alcoholic beverages often substitute for more nutritious foods in the diet and may lead to one or more nutritional deficiency disorders. Co-morbid conditions that are often precipitated by alcoholism-induced nutritional deficiencies may include, Wernicke-Korsakoff syndrome, peripheral neuropathies, behavioral changes, psychosis, delirium, cardiomyopathy and/or heart disease, skin disorders, gastrointestinal symptoms, megaloblastic anemia, hepatitis, stroke, and cancer.

The toll on society resulting from chronic, excessive intake of alcohol has been anything but subtle. In the United States, the total economic cost of alcohol abuse may be estimated at between $150-200 billion. Moreover, about 70% (about $130 billion) of the economic cost may be attributable to lost productivity in the workforce, either because of alcohol-induced illness and/or premature death. Likewise, about 14% (about $26 billion) of the economic cost may be attributable to health-care-related costs. Miscellaneous costs to society may also include costs associated with criminal law violations (e.g. driving while intoxicated, theft, assault, battery, and homicide), and destruction of property (e.g. automobile crashes).

Various prior art methods have unsuccessfully attempted to address the above nutritional deficiency issues resulting from chronic, excessive intake of alcohol. Such prior art may include oral and parenteral replacement therapies, detoxification therapies, and hangover remedies. While nutritional supplements in the form of oral and parenteral multivitamins have been known for some time, they are typically in a formulation administered separately from food and/or beverages.

Moreover, these supplements are typically administered as empiric and/or active treatments of an alcohol-induced nutritional deficiency. Applicant does not find in the available prior art a teaching of prophylactic treatment of a nutritional deficiency by the administration of a supplement directly to the food and/or beverage responsible for the nutritional deficiency and co-morbid conditions.

What is needed is a supplement introduced into a beverage or auxiliary comestible food to mitigate the nutrient depleting, nutrient deficient, or both properties of the beverage. What is needed is a nutritional supplement to function in a preventive role and be administered at the same time as the nutrient-deficient or nutrient-leaching beverage.

Therefore, what is needed is a nutrient supplement formulation and methods for introducing a formulation into a beverage such that nutrient depletion, nutrient deficiency, or both properties of the beverage may be mitigated or altogether eliminated.

Moreover, what is further needed is a nutrient formulation and methods for introducing a formulation into an auxiliary comestible food to be consumed in combination with a beverage that is nutrient deficient, nutrient depleting, or both.

Supplementation of beverages and/or auxiliary comestibles with important nutrients may not be intended to prevent alcoholism and may not completely prevent nutrient deficiency disorders. However, supplementation may reduce the sequelae and economic costs associated with these conditions caused by nutrient depletion and/or nutrient deficiency.

### BRIEF SUMMARY AND OBJECTS OF THE INVENTION

Consistent with the foregoing objects, and in accordance with the invention as embodied and broadly described herein, compositions and methods for introducing a nutritional supplement into a beverage or comestible food are disclosed. The compositions may include a beverage comprising a liquid directly ingestible by a user. An active ingredient may be added to the beverage in an amount effective to increase nutritional constituents otherwise subject to a deficiency in a user as a normal consequence of consumption of the beverage. A chemical excipient may be applied to the active ingredient. Excipients may be selected from, for example, anti-oxidants, pH buffers, flavor masking agents, odor masking agents, preservatives, timed-release mechanisms added to the beverage to support delivery of the active ingredient from the beverage to the bloodstream of a user.

The compositions may further include a comestible food directly ingestible by a user. An active ingredient may be added to the comestible food in an amount effective to increase nutritional constituents otherwise subject to a deficiency in a user as a normal consequence of consumption of a beverage. A chemical excipient may be applied to the active ingredient. These may include, for example, anti-oxidants, pH buffers, flavor masking agents, odor masking agents, preservatives, timed-release mechanisms added to the comestible food. These may support delivery of the active ingredient from the comestible food to the bloodstream of a user.

Other active ingredients may include, for example, vitamins, minerals, electrolytes, hormones, herbal material, botanicals, amino acids, proteins, carbohydrates, fats, or the like.

In addition, the compositions may include an excipient selected to mollify an effect, such as digestive processes, blood absorption processes, chemical stability prior to ingestion, chemical stability following ingestion, chemical longevity in the bloodstream, chemical stability in human cells. The composition may also apply one or more excipients in accordance with a parameter such as preservation, shelf-stability, lubrication, solvents, viscosity, flavor masking, odor masking, pharmacokinetic mollification, appearance, texture, taste.

A method in accordance with the invention may increase nutritional constituents otherwise subject to a deficiency in a user as a normal consequence of consumption of a beverage. A method in accordance with the invention may increase nutritional constituents through directly supplementing a beverage or directly supplementing a comestible food, typically consumed at substantially the same time as the beverage (e.g. snacks, hors d'oeuvres, meals, mixers, etc.).

A method in accordance with the invention may include direct supplementation of the beverage during beverage production, packaging, or distribution. Production of a beverage may include harvesting, crushing, milling, mashing, mixing, heating, fermenting, filtering, distilling, aging, extruding, or the like. Packaging of a beverage may include bottling, canning, kegging, barreling, or the like. Distribution of a beverage may include selling, delivering, serving, mixing, or the like, including placing the nutrient into a form or carrier to be consumed contemporaneously with the beverage.

In certain embodiments, nutrient supplementation of a beverage may be in the form of a pill, powder, tablet, capsule, granule, microgranule, liquid, suspension, emulsion, liquid concentrate, or effervescent tablet to be introduced into the beverage during production, packaging, or distribution and may be introduced by a beverage manufacturer, packager, server, or consumer.

In certain embodiments, the effective amount of an active ingredient in a nutrient supplement may be some fraction or percentage of the RDA guideline for the selected active ingredient.

### BRIEF DESCRIPTION OF THE DRAWINGS

The foregoing and other objects and features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a schematic block diagram illustrating one embodiment of a composition for supplementing a beverage with an active ingredient-selected to compensate for a nutrient deficiency, an excipient, and a delivery formulation;

FIG. 2 is a schematic block diagram illustrating one embodiment in accordance with the present invention providing a fortified beverage having a base beverage and a nutrient supplement;

FIG. 3 is a schematic block diagram illustrating one embodiment in accordance with of the present invention, including a method for introducing a nutrient supplement into a beverage or a comestible food;

FIG. 4 is a schematic block diagram illustrating one embodiment of a process for observing nutrient intake in a sample or target population;

FIG. 5 is a schematic block diagram illustrating one embodiment of a method or flow of steps for making, evaluating, and producing a nutrient supplement for introduction into a beverage or comestible food;

FIG. 6 is a schematic block diagram illustrating one embodiment of a method or flow of steps for introducing a nutrient supplement into a beverage;

FIG. 7 is a schematic block diagram illustrating one embodiment of a method or flow of steps for introducing a nutrient supplement into a comestible food;

FIG. 8 is a schematic illustration of one embodiment of a method for administering a fortified beverage including a base beverage and a supplement composition; and

FIG. 9 is a schematic illustration of one embodiment of a method for administering a fortified comestible food including a base food and a supplement composition.

### DETAILED DESCRIPTION OF THE PREFERRED EMBODIMENTS

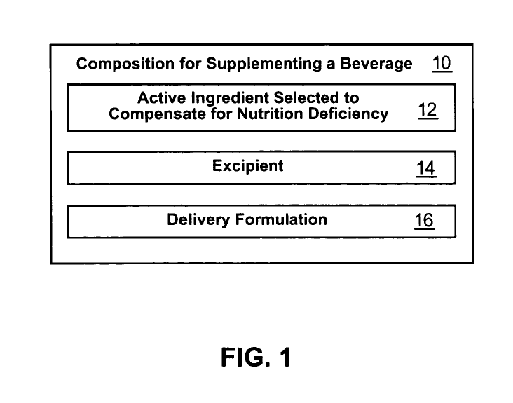

It will be readily understood that the components of the present invention, as generally described and illustrated in the Figures herein, could be arranged and designed in a wide variety of different configurations. Thus, the following more detailed description of the embodiments of systems and methods in accordance with the present invention, as represented in FIGS. 1 through 9, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

For the purposes of establishing definitional support for various terms used in the present application, Applicant provides the following technical comments and review. The term “addiction” may designate a compulsive and otherwise uncontrolled use of habit-forming substances (e.g. alcohol) for a time period beyond any recognized medical need or under any condition harmful to society.

The term “alcohol” encompasses many chemical compounds, but may often be used synonymously with ethyl alcohol—a colorless, volatile, flammable liquid with the empirical chemical formula: C₂H₅OH. Alcohol may be formed by vinous fermentation and may be the intoxicating component contained in wine, beer, whiskey, and other fermented and distilled liquors.

The term “alcoholism” may be used synonymously with “alcohol abuse” and may define a habit of chronic, continuous and usually excessive use of alcohol and/or alcoholic drinks.

A “co-morbid” condition, disease, illness, or disorder is one that exists simultaneously with and usually independently of another medical condition. In some instances there may be a cause and effect relationship between co-morbid conditions.

The term “comestible” means that something is suitable to be eaten or otherwise orally ingested.

An “electrolyte” includes a chemical substance that functions in solution as an electrical conductor (e.g. as a solution, liquid, or fused solid) in which current is carried by the movement of ions instead of electrons. Ions may include, for example, potassium, sodium, chloride, calcium, and phosphate.

An “excipient” may include an “inert” substance (e.g. gum arabic, syrup, lanolin, starch, etc.) that forms a vehicle to help deliver an active ingredient (e.g. a drug, a nutrient). An excipient may impart physical or chemical characteristics to a mixture that promote texture, phase, or the like, or the adhesive or other qualities needed for preparing a formulation (e.g. pills, tablets, suspensions, emulsions, capsules).

A “mineral” includes a chemical element or compound, with a characteristic solid homogeneous crystalline form, that may result from natural inorganic processes.

The term “mollify” means a modification, typically a reduction, in the intensity, stiffness, rigidity or a particular characteristic or trait in order to make a more uniform composition.

The term “morbidity” designates a disease state, condition, sign or symptom and may further designate the incidence of a disease state, condition, sign or symptom.

A “nutrient” designates a nutritious substance or component. A nutrient may be micromolecular (e.g. vitamin, mineral, electrolyte) or macromolecular (e.g. fat, protein, carbohydrate) in size. In some instances a vitamin may be large enough to be classified as macromolecular, and some protein components (e.g. amino acids) and carbohydrates may be small enough to be classified as micronutrients.

A “vitamin” designates any of various organic substances that may be essential to the physiology and function of many animals. Vitamins may act in minute amounts in the regulation of various metabolic and biochemical reactions but do not themselves provide energy or serve as building units. Vitamins are typically present in small amounts in various natural foodstuffs and are in some instances produced within the body, but are not ordinarily synthesized or stored in quantity in the human body. Vitamin deficiency conditions may be detected by the presence of specific signs or symptoms, which may be relieved by administration of the appropriate deficient vitamin. Vitamins may be commonly classified according to their water or fat solubility, their physiologic effects, or their chemical structure.

Many of the functional units described in this specification have been labeled as block diagram elements, in order to more particularly emphasize their implementation independence. For example, one embodiment in accordance with the present invention may implement incorporation of a nutrient supplement composition into a beverage. Consistent with the embodiment, a nutrient supplement may be introduced at the beverage production step, beverage packaging step, or beverage distribution step.

Referring to FIG. 1, a composition 10 for supplementing a beverage may comprise an active ingredient 12 selected to compensate for a nutrient deficiency, an excipient 14, and a delivery formulation 16. A composition 10 may be in a beverage form, wherein the beverage form is a commercially available, or even a traditional drink. A composition 10 in the form of a liquid beverage may be directly ingestible by a user.

The consumption of certain beverages by a user may contribute to an alteration in nutritional status necessitating the supplementation with compositions and methods of the present invention. For example, and not by way of limitation, beverages that may contribute to an alteration in nutritional status may include water, milk, juice, alcoholic beverages, coffee, tea, and carbonated beverages (e.g. soda pop, soft drinks). Moreover, alcoholic beverages may further include distilled spirits, beer, wine, champagne, brandy, cognac, malt beverages, hard ciders, ales, lagers, liqueurs, and the like.

An active ingredient 12 may be added to the composition. The amount is selected to be effective to increase the quantity of a nutritional constituent that may be available in the bloodstream before or after it may become deficient in a consumer of a nutrition-altering beverage.

An excipient 14 may be applied to the active ingredient. The excipient 14 may be selected from anti-oxidants, pH buffers, flavor masking agents, odor masking agents, preservatives, timed-release mechanisms, or the like added to the beverage to support delivery of the active ingredient from the beverage to the bloodstream of a user.

A delivery formulation 16 for a nutrient supplement composition 10 may be of any general formulation. It may include, for example and not by way of limitation, a formulation such as a powder, pill, tablet, capsule, granule, microgranule, liquid, suspension, emulsion, liquid concentrate, effervescent tablet or the like.

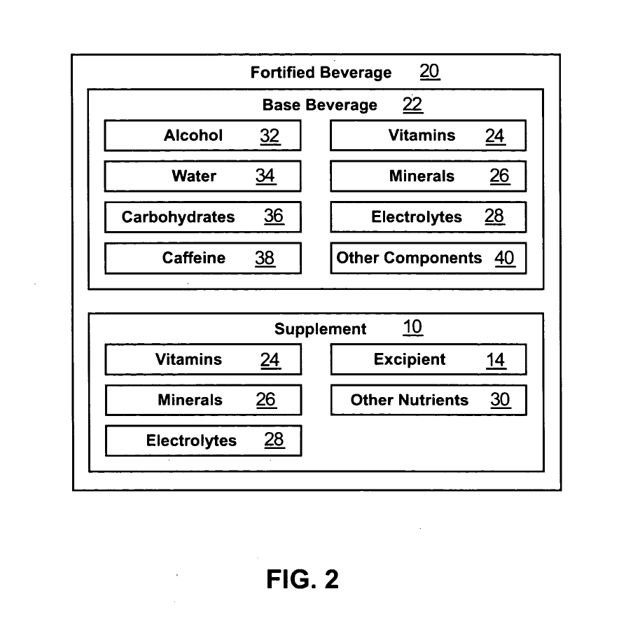

Referring to FIG. 2, a schematic block diagram illustrates one embodiment of a fortified beverage 20 comprising a base beverage 22 and a nutrient supplement composition 110. A base beverage 22 may include a vitamin 24, a mineral 26, an electrolyte 28, alcohol 32, water 34, a carbohydrate 36, caffeine 38, or other base component 40. Alcohol 32 may often be ethyl alcohol (i.e., C₂H₅OH), a primary intoxicating compound typically found in alcoholic beverages. Alcohol 32 may be a colorless, volatile compound that may result from the fermentation of certain fruits, vegetables and grains.

Carbohydrates 36 may generally include any member of a group of organic compounds that includes sugars, starches, celluloses, gums, and the like. Carbohydrates 36 may primarily be considered as a macronutrient compound. Carbohydrates 36 may be important to maintain a proper dietary balance. However, in excessive amounts, carbohydrates 36 may contribute significant additional calories (i.e., thermal energy units) that may be beyond the capacity of the body to utilize in energy requirements. Excess caloric intake may result in the production and storage of fat.

Caffeine 38 may be a stimulant compound frequently introduced into certain beverages, for example and not by way of limitation, coffee, tea, and soft drinks (e.g. carbonated beverages, soda pop). A base beverage 22 may additionally have other color or other components 40 that may or may not have functions in the base beverage 22.

A nutrient supplement composition 10 may have a vitamin 24, mineral 26, electrolyte 28, excipient 14, and other nutrients 30. A vitamin 24, may be a water-soluble or fat-soluble vitamin, or combination thereof. A vitamin 24 may be selected from B-Vitamins, Vitamin C, Vitamin A, Vitamin D, Vitamin E, Vitamin K, pro-vitamins, co-enzymes, or the like.

B-vitamins may be commonly referred to as “B-complex.” B-complex vitamins may be selected from Vitamin B1 (i.e., thiamine), Vitamin B2 (i.e., riboflavin), Vitamin B3 (i.e., niacin), Vitamin B5 (i.e., pantothenic acid), Vitamin B6 (i.e., pyridoxine), Vitamin B12 (cyanocobalamin), and folate (folic acid; sometimes referred to as Vitamin B9), or the like. The B-complex vitamins may have significant function in intermediary metabolism.

A pro-vitamin may be defined as a precursor of a vitamin, a substance that may be converted to a vitamin by the metabolic and biochemical processes within an animal. Carotene and ergosterol are just two of many examples of pro-vitamins. Certain vitamins 24 also may require the presence of a co-factor, sometimes synonymously used with the term co-enzyme, in order to properly function. Vitamin co-factors may include, for example and not by way of limitation, flavin adenine dinucleotide (FAD), nicotinamide adenine dinucleotide (NAD), nicotinamide adenine dinucleotide phosphate (NADP), thiamine pyrophosphate (TPP), coenzyme A (CoA), pyridoxal phosphate, methylcobalamin, and derivatives of tetrahydrofolate (THF).

A mineral 26 may further comprise magnesium, selenium, zinc, iron, and/or calcium. A mineral 26 may be used in the development of various solid anatomical structures within the body (e.g. bones, teeth, etc.), in the development of various compounds within the body, especially organic-metallic compounds (e.g. hemoglobin, etc.), and as co-factors in various metabolic and biochemical pathways within the body, especially in pathways that produce and/or consume energy (e.g. pathways involving adenosine triphosphate).

The RDA for magnesium in adults may be in the range of from about 300 mg to about 350 mg. The RDA for selenium in adults may be in the range of from about 55 mcg to about 70 mcg. The RDA for zinc in adults may be in the range of from about 12 mg to about 15 mg. The RDA for iron in adults may be in the range of about 10 mg to from about 18 mg. The RDA for calcium in adults may be in the range of from about 800 mg to about 1200 mg.

An electrolyte 28 may further comprise potassium, sodium, chloride, and phosphorus. An electrolyte 28 may be used in the signaling and communication systems within the body, especially signaling systems between cells and within cells. The RDA for potassium in adults may be about 2000 mg. The RDA for sodium in adults may be about 500 mg. The RDA for chloride in adults may be 750 mg. The RDA for phosphorus in adults may be in the range of from about 800 mg to about 1200 mg.

Other nutrients 30 may include, for example and not by way of limitation, choline, inositol, paraminobenzoic acid (PABA), carnitine, hormone, herbal, botanical, amino acid, protein, carbohydrate, and fat.

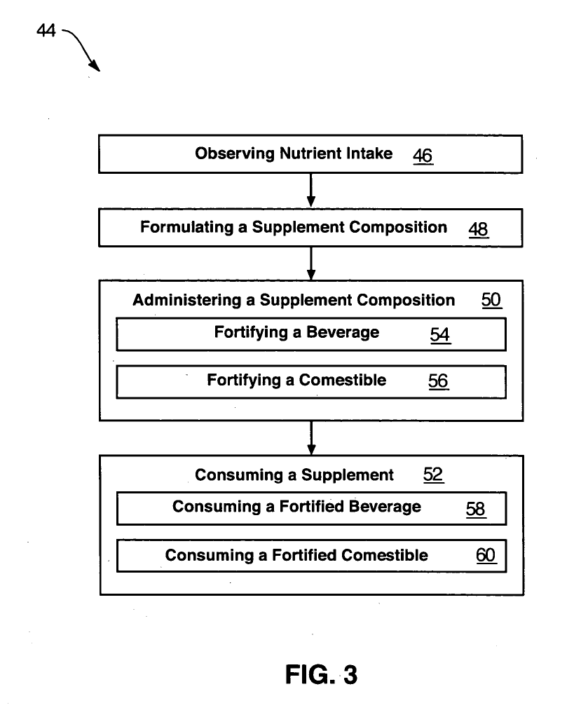

Referring to Figure and generally to FIGS. 3-9, one embodiment of a system in accordance with the present invention may include a method 44 for introducing a nutrient supplement 10 into a base beverage 22 or a base comestible food 23. A method 44 for introducing a nutrient supplement 10 may include the steps of observing 46 nutrient intake, formulating 48 a nutrient supplement composition 10, administering 50 a nutrient supplement composition 10, and consuming 52 a nutrient supplement composition. Testing and feedback may follow any step.

Administering 50 a supplement composition may include fortifying 54 a base beverage 22 or fortifying 56 a base comestible 23 food. Consuming 52 a nutrient supplement composition 10 may include consuming 58 a fortified beverage or consuming 60 a fortified comestible food.

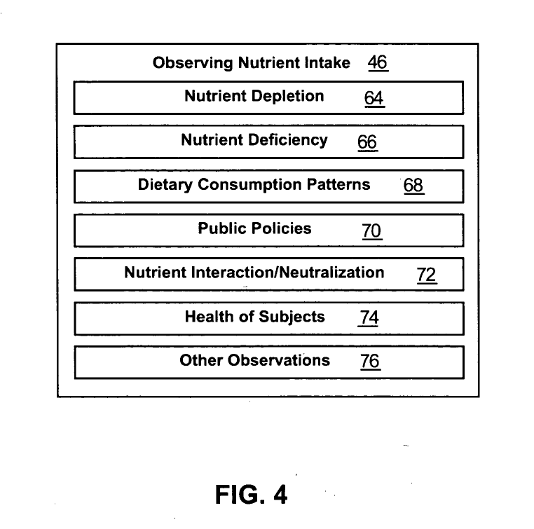

Referring to FIG. 4, observing 46 nutrient intake may further include observations of nutrient depletion 64, nutrient deficiency 66, dietary consumption patterns 68, public policies 70, nutrient interaction and/or neutralization 72, health of subjects 74, or other nutrient intake observations 76.

Nutrient depletion 64 may appear in observations where the body of an animal or human may have been at normal storage, capacity, or both, but due to any number of factors the storage, capacity, or both have been reduced or eliminated. Nutrient depletion 64 factors may include interference with nutrient absorption, leaching out, interaction between nutrients and other drugs or compounds, and the like.

Nutrient deficiency 66 may appear in observations where the body of an animal or human may be receiving an inadequate supply of a nutrient. A nutrient deficiency 66 does not necessarily require the animal or human to have ever been at a normal storage, capacity, or both. A nutrient deficiency 66 may refer to a condition where a nutrient may be at a defective, inadequate, or otherwise dysfunctional level or amount within the body of an animal or human. Accordingly, a nutrient deficiency 66 may incorporate nutrient depletion 64 as a subset thereof.

Observations of factors contributing to a nutrient deficiency 66 may include dietary consumption patterns 68, genetic factors, co-morbid conditions, co-administered compounds (e.g. medications, drugs, etc.). Dietary consumption patterns 64 may include observations of quantity and/or quality of nutrient intake. Observations of dietary consumption patterns 64 may reveal macronutrient intake, for example and not by way of limitation, fats, protein, amino acids, carbohydrates 36, and fiber. Observations of dietary consumption patterns 64 may include micronutrient intake, for example and not by way of limitation, vitamins 24, minerals 26, and electrolytes 28.

Observing nutrient intake 46 may also include observing and evaluating public policies 70 related to nutrition. Public policies 70 may involve data related to legislation and laws regarding nutrition, economic considerations, or public health programs, as well as sociological and other considerations.

Nutrient interaction 72 may involve leaching, consumption, neutralization, or the like, and may occur when the administration of or exposure to a compound (e.g. food, drug, medication, chemical, other nutrient) causes a nutrient to be inactivated, neutralized, or the like. A compound may typically interact with a nutrient in one or more of the following ways: (1) interfering with the absorption of a nutrient; (2) causing a nutrient to be more rapidly metabolized; (3) causing a nutrient to be more rapidly eliminated from the body; and (4) causing a nutrient to be displaced or redistributed from its normal storage site, utilization site, or transportation vehicle. A nutrient interaction 72 may cause a nutrient depletion 64 and a nutrient deficiency 66.

Observing nutrient intake 46 may also include observing health of subjects 74 in a sample or target population. Health of subjects 74 may include physical conditions and mental conditions. Observing nutrient intake 46 may include other observations 76 related to the intake and disposition of nutrients and the effects of nutrient levels on homeostasis in animals and humans.

Humans that may consume alcoholic beverages in chronic, excessive quantities may experience significant alterations in dietary consumption patterns 68 and may experience a nutrient interaction 72. Alterations in dietary consumption patterns 68 may cause a nutrient depletion 64 or nutrient deficiency 66 of a vitamin 24, mineral 26, or electrolyte 28. Humans consuming chronic, excessive quantities of alcoholic beverages may experience a nutrient deficiency 66, especially a deficiency of vitamin B1, vitamin B6, vitamin B12, folate, magnesium, selenium, or zinc. A vitamin 24, mineral 26, or electrolyte deficiency or depletion may directly impact the health of the subject 74, or may precipitate changes in an individuals' lifestyle, career, or financial condition.

Observing nutrient intake 46 in an animal or human, for example, may include observing a nutrient deficiency 66 of one or more vitamins 24. A vitamin 24 deficiency 66 may result in a fairly predictable set of clinical signs and symptoms. A nutrient deficiency 66 of vitamin B1 (thiamine) may result in a condition known as beriberi. Clinical manifestations of beriberi may include effects on the nervous system and the cardiovascular system. For example, beriberi may include signs and symptoms of peripheral neuritis with sensory disturbances in the extremities. Muscle strength may be reduced and may range from localized weakness to complete paralysis. There may also be changes in behavior and mental performance.

In moderate to severe cases of beriberi, a condition known as Wernicke's encephalophathy, Korsakoffs psychosis, or both may develop. These conditions are sometimes referred to together as Wernicke-Korsakoff syndrome (WKS). Beriberi may also result in any number of cardiovascular symptoms including, but not limited to, dyspnea, palpitation, tachycardia, electrocardiogram (ECG) rhythm disturbances, cardiac failure, and edema. The RDA for thiamine in adults may be in the range of from about 1.0 mg to about 1.4 mg.

Other nutrient deficiencies 66 that may be more common in humans consuming chronic, excessive quantities of alcoholic beverages may also be known. A nutrient deficiency 66 of vitamin B6 (pyridoxine) may result in a condition with symptoms affecting the skin and nervous system. A vitamin B6 deficiency may cause the skin and mucous membranes to develop seborrhea-like lesions. Such lesions may appear around the eyes, nose and may also be in the oral cavity and gastrointestinal lining. Lesion treatment may be highly responsive to supplemental administration of pyridoxine. Pyridoxine deficiency may also result in seizures and convulsions. The RDA for pyridoxine in adults may be in the range of from about 2.0 mg to about 2.2 mg.

A nutrient deficiency 66 of vitamin B12 (cyanocobalamin) and/or folate may result in an anemia condition, especially a condition known as megaloblastic anemia. Cyanocobalamin and folate may have roles in helping with cellular division during cell proliferation and development. A deficiency of either of these compounds may result in unusually large blood cells, which may have little or none of their intended functional capability. The RDA for cyanocobalamin in adults may be from about 3.0 mcg and the RDA for folate in adults may be about 400 mcg.

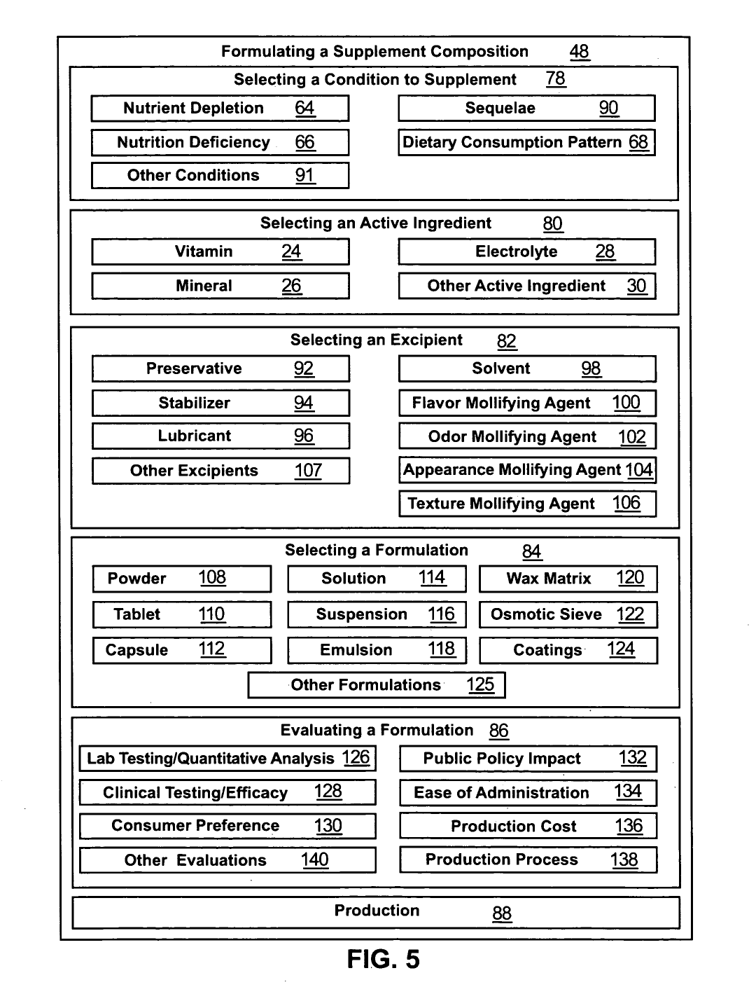

Referring to FIG. 5, one embodiment of a system in accordance with the present invention may include a method 48 for making, evaluating and producing a nutrient supplement 10 for introduction into a base beverage 22 or base comestible food 23. A method 48 of formulating a nutrient supplement composition 10 may include selecting 78 a condition to supplement, selecting 80 an active ingredient 12, selecting 82 an excipient 14, selecting 84 a formulation 16, evaluating 86 a nutrient supplement composition 10, and producing 88 a nutrient supplement composition 10.

Selecting 78 a condition to supplement 78 may further include selecting a nutrient depletion 64, nutrient deficiency 66, sequelae 90 of a nutrient deficiency 66, dietary consumption pattern 68, or other conditions associated with nutrient deficiency 91. A nutrient depletion 64 condition may exist when a nutrient may have been at normal storage levels or capacity and subsequently may be at reduced, or unavailable levels. A nutrient deficiency 66 may exist when a nutrient may be at a reduced or unavailable level irrespective of whether the nutrient was ever at a normal storage level or capacity.

Sequelae 90 or consequences of a nutrient deficiency 66 condition may include co-morbid conditions, secondary effects, latent effects, or the like that may occur sometime following the initial nutrient deficiency 66. For example, Wernicke-Korsakoff Syndrome, cirrhosis, pancreatitis, neuropathy and other nutrient deficiency conditions 91 may not necessarily occur immediately following nutrient deficiency 64 or nutrient depletion 66 in humans who may consume chronic, excessive amounts of alcoholic beverages. Rather these conditions may develop over time as sequelae 90 of alcohol abuse.

Selecting 80 an active ingredient 12 may include deciding which vitamin 24, mineral 26, electrolyte 28, other active ingredient 30, or combination thereof to include within a nutrient supplement composition 10.

Selecting 82 an excipient 14 may include deciding whether to incorporate one or more excipients such as the following: a preservative 92 (e.g. antimicrobial, anti-oxidant), a stabilizer 94 (e.g. pH acidifier, pH buffer), a lubricant 96 (e.g. magnesium stearate, lactose, starch, cellulose), a solvent 98 (e.g. polyethylene glycol, water, glycol), a flavor mollifying agent 100, an odor mollifying agent 102, an appearance mollifying agent 104, a texture mollifying agent 106, or other excipient 107.

A stabilizer 94 may be used to promote stability of an active ingredient 24 within a formulation vehicle 16, or within a base beverage 22 or base comestible food 23 and may otherwise contribute to increasing the shelf-life of a nutrient supplement composition 10. A mollifying agent may be any agent or compound that varies, neutralizes, or masks an unpleasant sensory characteristic of a nutrient supplement composition 10. Sensory characteristics may include taste, odor, texture, and appearance, for example.

Selecting 84 a formulation 16 may include selecting a delivery form such as, for example, powder 108, tablet 110, capsule 112, solution 114, suspension 116, emulsion 118, wax matrix 120, osmotic sieve 122, formulation coatings 124, or other formulations 125. A formulation 16 for a nutrient supplement composition 10 may utilize any form that optimizes incorporation into a base beverage 22 or a base comestible food 23 or optimize administration.

For example, a powder formulation 108 may be utilized when incorporating a nutrient supplement composition 10 directly into a base beverage 22 during its production. Incorporation of a powder formulation 108 may be desirous, for example, when an alcoholic beverage (e.g. beer) may be undergoing a final mixing stage just prior to packaging. The powder formulation 108 may then be easily introduced into the base beverage 22.

Tablets 110, capsules 112, suspensions 116, emulsions 118, wax matrices 120, osmotic sieves 112, and formulation coatings 124 may be useful formulations for imparting a timed-release or sustained-release properties to a nutrient supplement composition 10. Such timed-release properties may be desirous, for example, when a greater concentration of active ingredient 12 may be utilized, when timing of the consumption of base beverage 22 or base comestible food 23 may be important, or the like.

Evaluating 86 a nutrient supplement composition 10 may include selecting a process, such as, for example, laboratory testing and quantitative analysis 126, clinical and efficacy testing 128, consumer preference 130, impact on public policy 132, ease of administration 134, production cost 136, and production process 138. Quantitative analysis 126 may help to determine if the nutrient supplement composition 10 has the properly labeled amounts of active ingredient 12, excipient 14, and may help determine if the composition 10 contains any unwanted contaminants.

Efficacy testing 128 may be undertaken to evaluate whether the quantity or quality of active ingredients 12 is effective in ameliorating the selected 78 condition for which a nutrient supplement composition 10 is provided.

Consumer preference 130 may be evaluated to determine desirous qualities, especially sensory characteristics (e.g. taste, odor, texture, appearance) to incorporate into a nutrient supplement composition 10.

Public policy impact 132 may include, for example, whether a nutrient supplement composition 10 may reduce economic cost to society by ameliorating the selected 78 condition. With respect to alcoholic beverage consumption, public policy impact 132 of a nutrient supplement composition may evaluate reductions in lost work time, public medical costs, improvements in health of subjects 74 in a sample or target population, or the like.

Ease of administration 134, production cost 136, and production process 138 may be self-explained in their titles, but may nevertheless be important considerations in evaluating whether a nutrient supplement composition 10 should proceed to full commercial production 88.

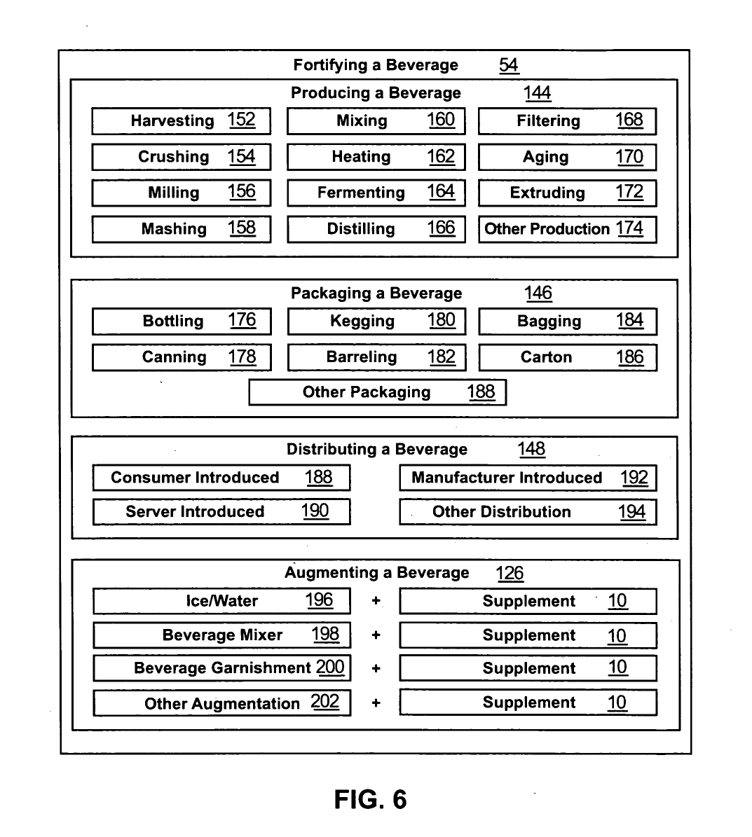

Referring to FIG. 6, one embodiment of a system in accordance with the present invention may include a method 54 for introducing a nutrient supplement composition 10 into a base beverage 22. A method 54 for introducing a nutrient supplement composition 10 may include introduction at any of the following steps, for example: producing 144 a base beverage 22, packaging 146 a base beverage 22, distributing 148 a base beverage 22, and augmenting 150 a base beverage 22.

Producing 144 a base beverage 22 may include any number of steps desirous for incorporation of a nutrient supplement composition 10. Such steps may include harvesting 152, crushing 154, milling 156, mashing 158, mixing 160, heating 162, fermenting 164, distilling 166, filtering 168, aging 170, extruding 172, or other production steps 174.

For example, certain base beverages 22, more particularly alcoholic beverages, may be derived from grains or fruit or vegetable products. Accordingly, alcoholic beverage production 144 may begin by harvesting 152 grapes in the production 144 of wines, champagne, etc., or by harvesting 152 hops in the production 144 of beer, ale, lager, etc. A nutrient supplement formulation may be applied onto grains or fruit just prior to or immediately following harvesting 152.

Continuing with the example of alcoholic beverage production 144, a nutrient supplement composition 10 may be applied to grains or fruits or vegetables when undergoing crushing 154, milling 156, mashing 158, mixing 160, heating 162, fermenting 164, distilling 166, filtering 168, aging 170, or other process at a production facility. Application of a nutrient supplement composition 10 during the crushing 154 or milling 156 steps may be advantageous for minimizing production cost 136, minimizing production process 138, or maximizing ease of administration of a nutrition supplement composition 10.

Applying a nutrient supplement composition 10 may also be desirous during mixing during or before an extrusion process 172. An extrusion process 172 may frequently be used in the production of snack foods and cereals. Multiple production steps may occur substantially simultaneously and may even occur within the same machine, process, or device.

Packaging 146 a base beverage 22 may include any number of steps such as, for example, bottling 176, canning 178, kegging 180, barreling 182, bagging 184, carton 186, and other packaging 188. Kegging 180 may be a form of barreling 182, wherein the amount is less than 30 gallons of base beverage 22. Packaging 146 a base beverage 22 may occur before the final production 144 stage is completed. For example, in some instances a beer, wine, or other alcoholic beverage may be placed into a barrel or keg prior to or during a fermenting 164, distilling 166, filtering 168, aging 172 or other production 174 step. Supplements may be added at the time of packaging.

Distributing 148 a base beverage 22 may be accomplished at any number of steps including consumer introduced 188, server introduced 190, manufacturer introduced 192, and other distribution 194 steps. For example, and not by way of limitation, a nutrient supplement composition 10 in a tablet 110 formulation may be introduced by a consumer 188 into a base beverage 22 (e.g. bottle of beer) just prior to consumption. A nutrient supplement composition 10 in a capsule 112 formulation may be opened by a server 190 (e.g. bartender) and introduced into a mixed drink just prior to being distributed to a consumer. Envelopes, bottles, powders, liquids, or the like may be used to introduce supplements in a stable form that will dissolve and disperse timely without dissipating in desired effect and without damaging taste, texture, color, etc. For example, fountain mixing or induction can add a supplement.

A manufacturer may introduce 192 a nutrient supplement composition 10 into a base beverage 22 that may have already undergone kegging 180, barreling 182, or packaging 146 step prior to the beverage entering mass distribution mechanisms.

Augmenting 150 a base beverage 22 may be accomplished at any number of steps and may include introducing a nutrient supplement composition 10 into ice or water 196, into a beverage mixer 198, into or onto a beverage garnishment 200, and other augmentation 202 methods.

A beverage mixer 198 may be either an alcoholic or non-alcoholic mixer. Examples of alcoholic mixers may include liqueurs (e.g. Creme de Menthe, Irish Cream, Amaretto, etc.). Examples of non-alcoholic mixers may include cocktail premixes (e.g. powders, flavors, etc.) where the only component missing is the distilled spirit (e.g. vodka, rum, tequila, whiskey, gin, etc.), and fruit or vegetables, juices, and concentrates (e.g. grenadine, lime concentrate, lemon juice, orange juice, tomato juice, etc), and the like.

Examples of a beverage garnishment 200 may or may not be comestible and may include portions of fruit or vegetables (e.g. olive, cherry, lemon, lime, etc.), salt, umbrella stick, toothpick, etc.

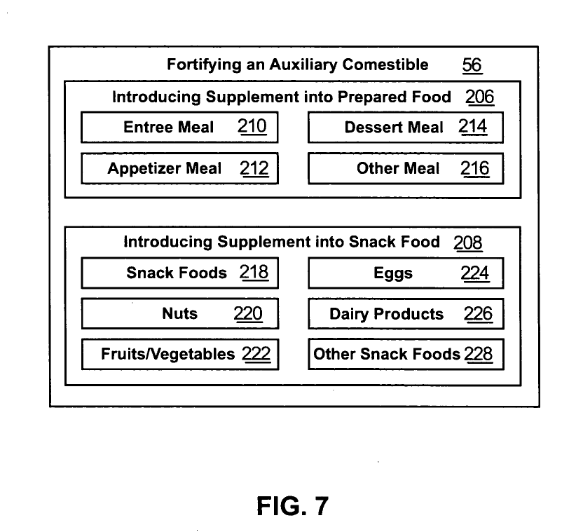

Referring to FIG. 7 one embodiment of a system in accordance with the present invention may include a method 56 for introducing a nutrient supplement composition 10 into a base comestible food 23. A method 56 may include introducing 206 a nutrient supplement composition 10 into a prepared food or introducing 208 a nutrient supplement composition 10 into a snack food. In this embodiment of the present invention, a nutrient supplement composition 10 is not directly introduced into a base beverage 22, however, a base comestible food 23 (e.g. nuts, chips, pretzels, etc.) may be selected that would normally accompany the consumption of a base beverage 22.

A prepared food may include an entree meal 210, an appetizer meal 212, a dessert meal 214, or other meal 216 or constituent thereof. For example, and not by way of limitation, a quantity of a nutrient supplement composition 10 in a solution 114 formulation may be introduced by a cook or consumer into a meat, poultry, seafood, casserole, or other entree meal 210 component during the cooking or preparation process. In an additional example, a quantity of a nutrient supplement composition 10 in a powder 108 formulation may be introduced into a dip, dressing, garnish, melted cheese, or the like used in the preparation or presentation of an appetizer meal 212 (e.g. nachos) or hors d'oeuvre.

Introduction 208 of a nutrient supplement composition 10 into a snack food 218 may include snack foods 218 in general (e.g. chips, pretzels, crackers), nuts 220, fruits or vegetables 222, eggs 224, pickles, dairy products 226 (e.g. cheese), and other snack foods 228. For example, a nutrient supplement composition 10 in a powder 108 formulation may be introduced into a cheese 226 product that may be intended to be consumed simultaneously with an alcoholic beverage (e.g. wine).

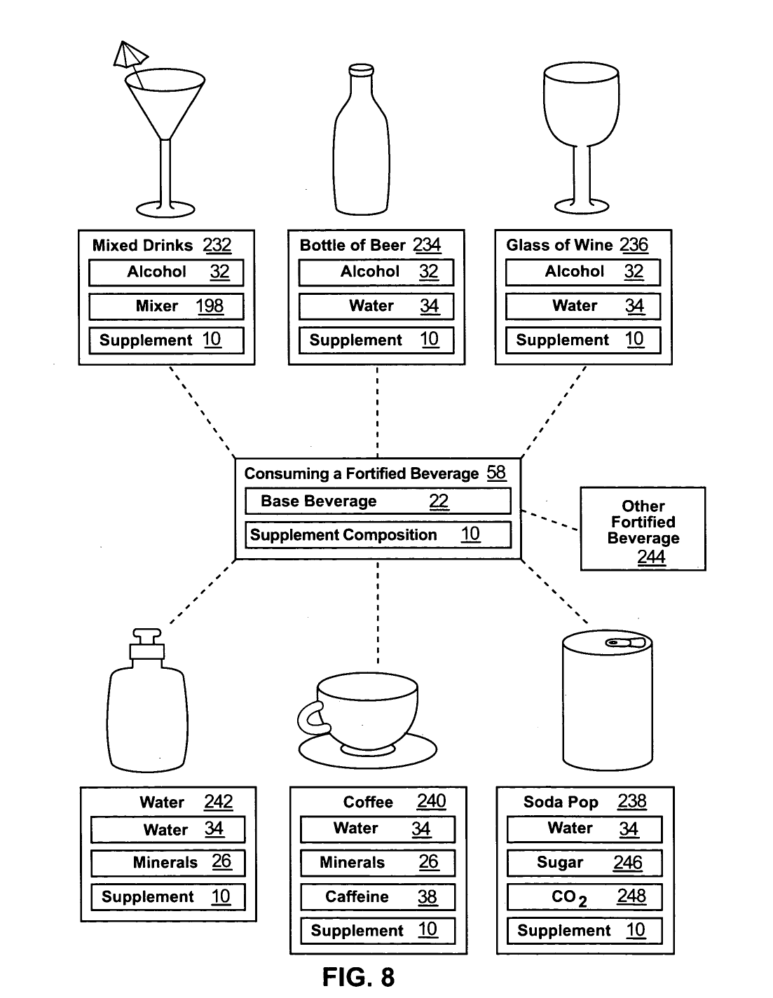

Referring to FIG. 8 one embodiment of a system in accordance with the present invention may include consuming a fortified beverage 58 having a base beverage 22 and a supplement composition 10. Consuming a fortified beverage 58 may include imbibing a mixed drink 232, beer 234 (e.g. bottle of beer), wine 236 (e.g. glass of wine), soda pop 238 (e.g. can of soda), coffee 240 (e.g. cup of coffee), water 242 (e.g. bottle of water), and other fortified beverages 244.

For example, and not by way of limitation, a mixed drink 232, may further comprise alcohol 32, one or more beverage mixer 198, ice, and a nutrient supplement composition 10. A beer 234 may include alcohol 32, water 34 and a nutrient supplement composition 10. A glass of wine 236 may include alcohol 32, water 34 and a nutrient supplement composition 10. A can of soda 238 may include water 34, sugar 246, carbon dioxide (CO₂) 248, and a nutrient supplement composition 10. A cup of coffee 240 may include water 34, minerals 26, extracts, caffeine 38, and a nutrient supplement composition 10. A bottle of water 242 may include water 34, minerals 26, and a nutrient supplement composition 10. Any of the foregoing examples may include flavors, colors, extracts, texture enhancers, or the like.

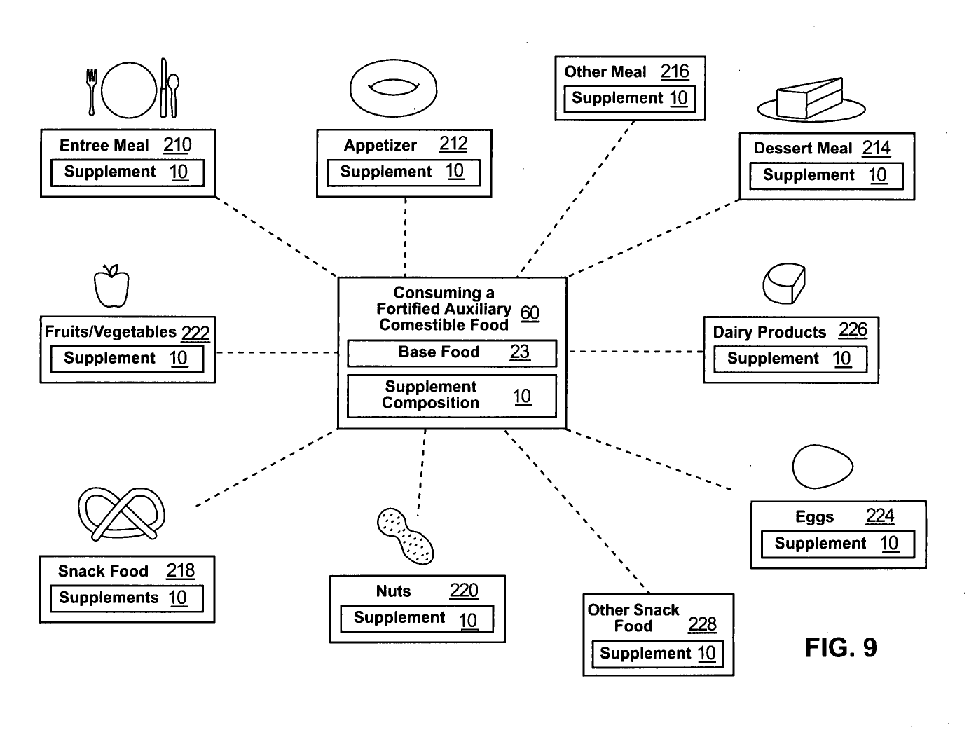

Referring to FIG. 9, one embodiment of the present invention may include consuming a fortified comestible food 60 that may comprise a base food 23 and a supplement composition 10. Consuming a fortified comestible food 60 may include an entree meal 210, appetizer meal 212, dessert meal 214, other meal 216, snack food 218, nuts 220, fruits or vegetables 222, eggs 224, dairy products 226, and other snack foods 228. All of these base comestible foods 23 may be fortified by the addition of a quantity of a nutrient supplement composition 10.

The following examples may illustrate practices in accordance with of the present invention in further detail. It will be readily understood by those skilled in the art that the following novel methods of the present invention for making and using fortified beverages and auxilliary comestibles, as generally described and illustrated in the Examples herein, are to be viewed as exemplary of the principles of the present invention, and not as restrictive to a particular structure or process for implementing those principles. Thus, the following more detailed description of the presently preferred embodiments of the novel methods of the present invention, as represented in Examples I-IV, is not intended to limit the scope of the invention, as claimed, but is merely representative of presently contemplated embodiments in accordance with the invention.

### EXAMPLE I

### Bottle of Beer Fortified with Nutrient Supplement

Based on the foregoing description and efforts of the inventors, one embodimentg may include selecting as a target population those individuals who consume chronic, excessive amounts of beer and may have a deficiency of vitamin B1, vitamin B6, folate, magnesium, selenium, and zinc.

A nutrient supplement composition 10 may include an effective amount of active ingredients 12 as follows: vitamin B1, vitamin B6, folate, magnesium, selenium, and zinc. For this example an effective amount was determined to be 10% of the RDA for the active ingredients.

A nutrient supplement composition 10 may include a sufficient quantity (QS) of excipient 14 appropriate to the selected formulation 16. For this example, a powder 108 formulation may be selected and may incorporate a preservative 92 (e.g. anti-oxidant), a stabilizer 94 (e.g. acidifying agent), a lubricant 96 (e.g. lactose), a flavor-mollifying agent 100, odor-mollifying agent 102, appearance-mollifying agent 104, and texture-mollifying agent 106. A nutrient supplement composition 10 may be formulated as described in table 1.

TABLE 1
Nutrient Supplement Composition Formulation No. 1 (10% RDA)

| Ingredient | Amount | |
|---|---|---|
| Active Ingredients | | |
| thiamine (B1) | 0.14 | mg |
| pyridoxine (B6) | 0.22 | mg |
| folic acid (B9) | 40 | mcg |
| magnesium | 35 | mg |
| zinc | 1.5 | mg |
| selenium | 7 | mcg |

| | |
|---|---|
| Chemical Excipients | |
| anti-oxidant | QS |
| acidifying agent | QS to pH of 3-6 |
| lactose | QS |
| flavor-masking | QS |
| odor-mollifier | QS |
| appearance-mollifier | QS |
| texture-masking | QS |

A nutrient supplement composition 10 according to this example may be incorporated by a beer manufacturer during the bottling process. A beer beverage that may be fortified with a nutrient supplement composition 10 of the present invention may be intended to have a taste, odor, appearance and texture that would exactly or closely match the taste, odor, appearance, texture of the non-fortified beer beverage.

Since the novel compositions and methods in accordance with the present invention are configured for compositions and methods for nutrient supplementation, it will be readily appreciated that a nutrient supplement composition 10 may include any number of variations of quality and quantity of active ingredients 12, excipients 14, and formulations 16. It is intended, therefore, that the examples provided herein be viewed as exemplary of the principles of the present invention, and not as restrictive to a particular structure or method for implementing those principles.

### EXAMPLE II

### Alcoholic Mixed Drink Fortified with Nutrient Supplement

Based on the foregoing description and efforts of the inventors, one embodiment may include selecting as a target population those individuals who consume chronic, excessive amounts of alcoholic mixed drinks and may have a deficiency of vitamin B1, vitamin B6, folate, vitamin B12, magnesium, and zinc. A nutrient supplement composition 10 may include an effective amount of active ingredients 12 as follows: vitamin B1, vitamin B6, folate, vitamin B12, magnesium, and zinc. For this example an effective amount was determined to be 20% of the RDA for the active ingredients.

A nutrient supplement composition 10 may include a sufficient quantity (QS) of excipient 14 appropriate to the selected formulation 16. For this example, a solution 114 formulation may be selected and may incorporate a preservative 92 (e.g. anti-oxidant), a stabilizer 94 (e.g. acidifying agent), a solvent 98 (e.g. water), a flavor-mollifying agent 100, odor-mollifying agent 102, appearance-mollifying agent 104, and texture-mollifying agent 106. A nutrient supplement composition 10 may be formulated as described in table 2.

TABLE 2
Nutrient Supplement Composition Formulation No. 2 (20% RDA)

| Ingredient | Amount | |
|---|---|---|
| Active Ingredients | | |
| thiamine (B1) | 0.28 | mg |
| pyridoxine (B6) | 0.44 | mg |
| folic acid (B9) | 80 | mcg |
| magnesium | 70 | mg |
| zinc | 3 | mg |
| cyanocobalamin (B12) | 0.6 | mcg |

| | |
|---|---|
| Chemical Excipients | |
| anti-oxidant | QS |
| acidifying agent | QS to pH of 3-6 |
| water | QS |
| flavor-masking | QS |
| odor-mollifier | QS |
| appearance-mollifier | QS |
| texture-masking | QS |

A nutrient supplement composition 10 according to this example may be incorporated into a mixed drink by a bartender during the mixed drink preparation process and subsequent distribution to a consumer. A mixed drink that may be fortified with a nutrient supplement composition 10 of the present invention may be intended to have a taste, odor, appearance and texture that would exactly or closely match the taste, odor, appearance, texture of the non-fortified mixed drink beverage.

Since the novel compositions and methods in accordance with the present invention are configured as compositions and methods for nutrient supplementation, it will be readily appreciated that a nutrient supplement composition 10 may include any number of variations of quality and quantity of active ingredients 12, excipients 14, and formulations 16. It is intended, therefore, that the examples provided herein be viewed as exemplary of the principles of the present invention, and not as restrictive to a particular structure or method for implementing those principles.

### EXAMPLE III

### Wine Fortified with Nutrient Supplement

Based on the foregoing description and efforts of the inventors, one embodiment may include selecting as a target population those individuals who consume chronic, excessive amounts of wine and may have a deficiency of vitamin B1, vitamin B6, folate, vitamin B12, vitamin C, magnesium, and zinc.

A nutrient supplement composition 10 may include an effective amount of active ingredients 12 as follows: vitamin B1, vitamin B6, folate, vitamin B12, vitamin C, magnesium, and zinc. For this example an effective amount was determined to be 20% of the RDA for the active ingredients.

A nutrient supplement composition 10 may include a sufficient quantity (QS) of excipient 14 appropriate to the selected formulation 16. For this example, a rapidly dissolving tablet 110 formulation may be selected and may incorporate a preservative 92 (e.g. anti-oxidant), a stabilizer 94 (e.g. acidifying agent), lubricants 96 (e.g. magnesium stearate, lactose), a flavor-mollifying agent 100, odor-mollifying agent 102, appearance-mollifying agent 104, and texture-mollifying agent 106. A nutrient supplement composition 10 may be formulated as described in table 3.

TABLE 3
Nutrient Supplement Composition Formulation No. 3 (20% RDA)

| Ingredient | Amount | |
|---|---|---|
| Active Ingredients | | |
| thiamine (B1) | 0.28 | mg |
| pyridoxine (B6) | 0.44 | mg |
| folic acid (B9) | 80 | mcg |
| magnesium | 70 | mg |
| zinc | 3 | mg |
| cyanocobalamin (B12) | 0.6 | mcg |
| vitamin C | 12 | mg |

| | |
|---|---|
| Chemical Excipients | |
| anti-oxidant | QS |
| acidifying agent | QS to pH of 3-6 |
| lactose | QS |
| flavor-masking | QS |
| odor-mollifier | QS |
| appearance-mollifier | QS |
| texture-masking | QS |

A nutrient supplement composition 10 according to this example may be incorporated into the outer packaging of a bottle of wine during the packaging process. When a member of the target population prepares a bottle of wine for consumption (i.e., removing packaging materials and cork), the member may insert a rapidly dissolving tablet 110 into the bottle of wine and gently mix. A wine beverage that may be fortified with a nutrient supplement composition 10 of the present invention may be intended to have a taste, odor, appearance and texture that would exactly or closely match the taste, odor, appearance, texture of the non-fortified beer beverage. The table 110 may also be ingested directly.

Since the novel compositions and methods in accordance with the present invention are configured as compositions and methods for nutrient supplementation, it will be readily appreciated that a nutrient supplement composition 10 may include any number of variations of quality and quantity of active ingredients 12, excipients 14, and formulations 16. It is intended, therefore, that the examples provided herein be viewed as exemplary of the principles of the present invention, and not as restrictive to a particular structure or method for implementing those principles.

### EXAMPLE IV

### Comestible Snack Food Fortified with Nutrient Supplement

Based on the foregoing description and efforts of the inventors, one embodiment may include selecting as a target population those individuals who consume chronic, excessive amounts of beer and may have a deficiency of vitamin B1, vitamin B6, folate, magnesium, selenium, and zinc.

A nutrient supplement composition 10 may include an effective amount of active ingredients 12 as follows: vitamin B1, vitamin B6, folate, magnesium, selenium, and zinc. For this example an effective amount was determined to be 100% of the RDA for the active ingredients.

A nutrient supplement composition 10 may include a sufficient quantity (QS) of excipient 14 appropriate to the selected formulation 16. For this example, a powder 108 formulation may be selected and may incorporate a preservative 92 (e.g. anti-oxidant), a stabilizer 94 (e.g. acidifying agent), a lubricant 96 (e.g. lactose), a flavor-mollifying agent 100, odor-mollifying agent 102, appearance-mollifying agent 104, and texture-mollifying agent 106. A nutrient supplement composition 10 may be formulated as described in table 4.

TABLE 4
Nutrient Supplement Composition Formulation No. 4 (100% RDA)

| Ingredient | Amount | |
|---|---|---|
| Active Ingredients | | |
| thiamine (B1) | 1.4 | mg |
| pyridoxine (B6) | 2.2 | mg |
| folic acid (B9) | 400 | mcg |
| magnesium | 350 | mg |
| zinc | 15 | mg |
| selenium | 70 | mcg |

| | |
|---|---|
| Chemical Excipients | |
| anti-oxidant | QS |
| acidifying agent | QS to pH of 3-6 |
| lactose | QS |
| flavor-masking | QS |
| odor-mollifier | QS |
| appearance-mollifier | QS |
| texture-masking | QS |

A nutrient supplement composition 10 according to this example may be incorporated by a manufacturer during the extrusion process. A snack food that may be fortified with a nutrient supplement composition 10 of the present invention may be intended to have a taste, odor, appearance and texture that would exactly or closely match the taste, odor, appearance, texture of the non-fortified snack food.

For all of the foregoing examples a formulation may have selected flavor enhancers or masking agents. Sugars, salts, citric acid, and the like will often serve this function. Other natural and artificial flavors may include flavors suitable for mixing or flavors corresponding to the natural taste of a base beverage or comestible.

Since the novel compositions and methods of the present invention are configured as compositions and methods for nutrient supplementation, it will be readily appreciated that a nutrient supplement composition 10 may include any number of variations of quality and quantity of active ingredients 12, excipients 14, and formulations 16. It is intended, therefore, that the examples provided herein be viewed as exemplary of the principles of the present invention, and not as restrictive to a particular structure or method for implementing those principles.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A composition for supplementing a beverage, the composition comprising:
a beverage comprising a liquid directly ingestible by a user;
an active ingredient added to the beverage in an amount effective to increase nutritional constituents otherwise subject to a deficiency in a user as a normal consequence of consumption of the beverage; and
a chemical excipient applied to the active ingredient selected from the group consisting of anti-oxidants, pH buffers, flavor masking agents, odor masking agents, preservatives, timed-release mechanisms added to the beverage to support delivery of the active ingredient from the beverage to the bloodstream of a user.

2. The composition of claim 1, wherein the beverage is a commercially available traditional drink.

3. The composition of claim 1, wherein the beverage comprises a substance selected from water, milk, juice, alcoholic beverages, coffee, tea, carbonated beverages.

4. The composition of claim 3, wherein alcoholic beverages further comprises distilled spirits, beer, wine, champagne, brandy, cognac, malt beverages, hard ciders, ales, lagers, liqueurs.

5. The composition of claim 1, wherein the active ingredient is selected from the group consisting of vitamins, minerals, electrolytes, hormones, herbal, botanical, amino acid, protein, carbohydrate, fat.

6. The composition of claim 5, wherein vitamins are selected from the group consisting of B-Vitamins, Vitamin C, Vitamin A, Vitamin D, Vitamin E, Vitamin K, pro-vitamins, and co-enzymes.

7. The composition of claim 6, wherein B-Vitamins are selected from the group consisting of Vitamin B1 (thiamine), Vitamin B2 (riboflavin), Vitamin B3 (niacin), Vitamin B5 (pantothenic acid), Vitamin B6 (pyridoxine), Vitamin B9 (folic acid), and Vitamin B12 (cyanocobalamin).

8. The composition of claim 4, wherein minerals further comprise at least one of magnesium, selenium, zinc, iron, and calcium.

9. The composition of claim 4, wherein electrolytes further comprise at least one of potassium, sodium, chloride, and phosphate.

10. The composition of claim 1, wherein the active ingredient is other than a replacement of a constituent previously present in the beverage.

11. The composition of claim 1, wherein the active ingredient is other than a replacement of a constituent of the beverage source materials previously present in a former condition of the beverage source materials.

12. The composition of claim 1, wherein the excipient is selected to mollify an effect selected from digestive processes, blood absorption processes, chemical stability prior to ingestion, chemical stability following ingestion, longevity of chemical concentration in the bloodstream, chemical stability in human cells.

13. The composition of claim 1, wherein the application of the excipient is ordered in accordance with a parameter selected from at least one of preservation, shelf-stability, lubrication, solvents, viscosity, flavor masking, odor masking, pharmacokinetic mollification, appearance, texture, taste.

14. The composition of claim 1, wherein the beverage is selected from the group consisting of nutritionally deficient and nutrition-depleting beverages.

15. The composition of claim 1, wherein the beverage consists of a liquid.

16. The composition of claim 1, wherein the effective amount is selected to substantially completely replenish a deficiency of a selected nutrient.

17. The composition of claim 1, wherein the effective amount is selected to substantially inhibit the depletion effects of the beverage on a selected nutrient.

18. The composition of claim 1, wherein the effective amounts is selected to substantially reverse the depletion effects of the beverage on a selected nutrient.

19. The composition of claim 1, wherein the effective amounts is selected to substantially neutralize depletion effects of the beverage on a selected nutrient.

20. The composition of claim 19, wherein the effective amount is selected to substantially maintain a concentration in a bloodstream of a user to substantially resist leaching of the selected nutrient from cells by the beverage in the bloodstream.

21. The composition of claim 1, wherein the composition is in a formulation selected from the group consisting of powder, pill, tablet, capsule, granule, microgranule, liquid, suspension, emulsion, liquid concentrate, effervescent tablet.

22. The composition of claim 1, wherein the beverage comprises a slurry comprising a solidus material in a liquid.

23. A method for increasing nutritional constituents otherwise subject to a deficiency in a user consequent to consumption of a beverage, the method comprising:
consuming a beverage having an effect reducing a first nutrient in an individual;
depleting the first nutrient in an individual consuming a first dose of the beverage;
supplementing a second dose of the beverage with a supplement; and
administering the beverage containing the supplement comprising the nutrient formulated to ingest with the beverage.

24. The method of claim 23, wherein the nutrient effect is selected from the group consisting of nutrient lacking, nutrient depleting, nutrient fortifying, and nutrient neutral.

25. The method of claim 23, wherein depleting the nutrient results from a process selected from the group consisting of organic consumption, illness, and pharmacokinetic interaction.

26. The method of claim 23, wherein supplementing the beverage further comprises introducing the nutrient formulation directly into the beverage.

27. The method of claim 26, wherein introducing the nutrient formulation into the beverage occurs during at least one of beverage production, packaging, and distribution of the beverage.

28. The method of claim 27, wherein production further comprises at least one of harvesting, crushing, milling, mashing, mixing, heating, fermenting, distilling, aging, and extruding.

29. The method of claim 27, wherein packaging further comprises at least one of bottling, canning, kegging, barreling, and cartoning.

30. The method of claim 23, wherein administering further comprises placing the nutrient into a carrier that is consumed contemporaneously with the beverage.

31. The method of claim 30, wherein the carrier is selected from the group consisting of an organic food, organic beverage, packaged food, packaged beverage, mixer formulation, and auxiliary comestible.

32. The method of claim 31, wherein the mixer formulation further comprises at least one of water, ice, garnishment, liqueur, grenadine, fruit, vegetable, juice, fruit concentrate, and vegetable concentrate.

33. The method of claim 30, wherein the auxiliary comestible further comprises at least one of snacks, hors d'oeuvres, nuts, pretzels, chips, crackers, boiled eggs, pickles, and cheese.

34. A method for making a supplemented beverage for increasing nutritional constituents otherwise subject to a deficiency in a user as a consequence of consumption of a beverage, the method comprising:
selecting a condition to supplement;
selecting an active ingredient;
selecting a chemical excipient for formulating the beverage supplement;
evaluating the beverage supplement;
incorporating the active ingredient and excipient into the beverage
administering the supplemented beverage to a user.

35. The method of claim 34, wherein the condition is selected from nutrient depletion, nutrient deficiency, hepatic condition, neurological condition, cardiovascular condition, endocrine condition, renal condition, gastrointestinal condition, respiratory condition.

36. The method of claim 34, wherein the active ingredient is selected from vitamin, mineral, electrolyte, hormone, herbal, botanical, amino acid, protein, carbohydrate, fat.

37. The method of claim 36, wherein vitamin is selected from the group consisting of B-Vitamins, Vitamin C, Vitamin A, Vitamin D, Vitamin E, Vitamin K, pro-vitamin, and co-enzyme.

38. The method of claim 37, wherein B-Vitamin is selected from the group consisting of Vitamin B1 (thiamine), Vitamin B2 (riboflavin), Vitamin B3 (niacin), Vitamin B5 (pantothenic acid), Vitamin B6 (pyridoxine), Vitamin B9 (folic acid), and Vitamin B12 (cyanocobalamin).

39. The method of claim 36, wherein the mineral is selected from the group consisting of magnesium, selenium, zinc, and calcium.

40. The method of claim 36, wherein the electrolyte is selected from the group consisting of potassium, sodium, and phosphate.

41. The method of claim 34, wherein formulating further comprises selecting a property from the group consisting of preservation, shelf-stability, lubrication, solvents, viscosity, flavor masking, odor masking, pharmacokinetic mollification, appearance, texture, taste, digestive processes, blood absorption processes, chemical stability prior to ingestion, chemical stability following ingestion, chemical longevity in the bloodstream, chemical stability in human cells.

42. The method of claim 34, wherein evaluating the beverage supplement is selected from the group consisting of performing a quantitative analysis of formulation components, performing a clinical analysis of effect of the beverage supplement on the selected condition, performing a consumer preference analysis.

43. The method of claim 42, wherein the consumer preference analysis further comprises testing for at least one of taste, odor, appearance, color, and texture.

44. The method of claim 34, wherein incorporating the active ingredient and excipient into a beverage is executed during a process selected from the group consisting of production, packaging, and distribution.

45. The method of claim 44, wherein the production further comprises at least one of harvesting, crushing, milling, mashing, mixing, heating, fermenting, distilling, aging, and extruding a source material.

46. The method of claim 44, wherein the packaging further comprises at least one of bottling, canning, kegging, barreling, and cartoning.
